(19) United States
(12) Patent Application Publication
(10) Pub. No.: US 2006/0080606 A1
(43) Pub. Date: Apr. 13, 2006

(54) System and method for model-specific web help

(76) Inventors: Glenn Lortscher, San Diego, CA (US); Dimitris Magemeneas, San Marcos, CA (US); Christopher Bjork, Poway, CA (US)

Correspondence Address: ROGITZ & ASSOCIATES, 750 B STREET, SUITE 3120, SAN DIEGO, CA, 92101, US

(21) Appl. No.: 11/238,948

(22) Filed: Sep. 29, 2005

Related U.S. Application Data
(60) Provisional application No. 60/618,213, filed on Oct. 13, 2004.

(51) Int. Cl. G06F 17/00

(52) U.S. Cl. 715/705

(57) ABSTRACT

A Web help utility allows a user to select the model number of an electronic product for which the user is experiencing problems, with the help utility thereafter presenting a list of commonly encountered problems with the particular model.

### RELATED APPLICATIONS

This application claims priority from U.S. provisional patent application Ser. No. 60/618,213 filed Oct. 13, 2004 and U.S. patent application Ser. No. 29/215,789 filed Oct. 25, 2004.

### FIELD OF THE INVENTION

The present invention relates generally to online user help systems.

### BACKGROUND OF THE INVENTION

Web help utilities have been introduced which users may access over the Internet to obtain help in resolving problems with electronic components such as TVs, computers, and the like. Current help utilities, as recognized herein, suffer from several drawbacks. Knowledge-based solutions require a user to input a question that is used to search a database, but because these solutions are not model-specific, incorrect information is often returned to the user. For example, a list of possible help topics may be returned in response to a query indicating a display problem, with the list including entries for various types of displays that the user may not possess and may indeed become confused by.

Moreover, if the user ineptly inputs a question, no answer at all may be found in the database, resulting in a “no problem found” message being returned as a response. As understood herein, the confusion and frustration caused by these problems often result in returned merchandise and service calls that are expensive and that project a poor product image. Indeed, experience has shown that consumers will quickly escalate problems that they cannot solve from the Web help support site to service calls, then to product returns.

Other online “help” systems are no more than electronic versions of operating manuals. These typically are static and do not have support information for problem solving. With these critical recognitions in mind, the solution herein is provided.

### SUMMARY OF THE INVENTION

A method for providing online help to a user includes prompting the user to enter a model designation of an electronic product for reception thereof over a wide area network, and based on the model designation, returning to the user, over the wide area network, at least one list of problems associated with the electronic product, assuming the product has been associated with known problems. The method includes receiving a user selection of an item on the list, and returning a proposed solution to the user based on the user selection. Without limitation the product may be, e.g., a visual display, a television, or a computer.

In non-limiting implementations the method includes presenting an entry page to the user listing product categories. The method may also include presenting a first sub-page to the user listing sub-categories of a category selected by the user from the entry page, and presenting, on the first sub-page, a model entry field into which the user can enter the model designation. A drop-down menu of model designations from which the user can select a model designation may also be presented. Instead of a drop-down menus, pictorial choices may be provided. In response, a second sub-page having content related to a model designation entered on the first sub-page is returned. The content can include a list of frequently asked questions related to the model designation from which the user can select, and the content does not include frequently asked questions not related to the model designation. Or, the content can include problem categories related to the model designation without including problem categories that are not related to the model designation. Still further, the content may include a window into which a user can enter a query, with the query being used to search a database for returning responses related only to the model designation.

In another aspect, a system for providing help to a user includes a server computer communicating with the Internet and executing logic that includes receiving a model designation of an electronic product from a user computer. Based on the model designation, a list of problems associated with the electronic product and which does not include any information not related to the electronic product is returned.

In yet another aspect, a model-specific help database system includes an Internet server computer and a database accessible to the server computer. The database associates common product problems with product model designations. With this structure, the server computer can query the database with a model designation and the database returns in response only common product problems associated with the model designation. In turn, the server computer sends the common product problems to a user computer over the Internet.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting help system according to the present invention;

FIG. 2 is a flow chart of non-limiting logic;

FIG. 3 is a screen shot of a non-limiting entry help page;

FIG. 4 is a screen shot of a non-limiting first level sub-page;

FIG. 5 is a screen shot of a non-limiting second level sub-page;

FIG. 6 is a screen shot of a non-limiting third level sub-page; and

FIG. 7 is a screen shot of a non-limiting fourth level sub-page.

### DETAILED DESCRIPTION OF THE PREFERRED EMBODIMENT

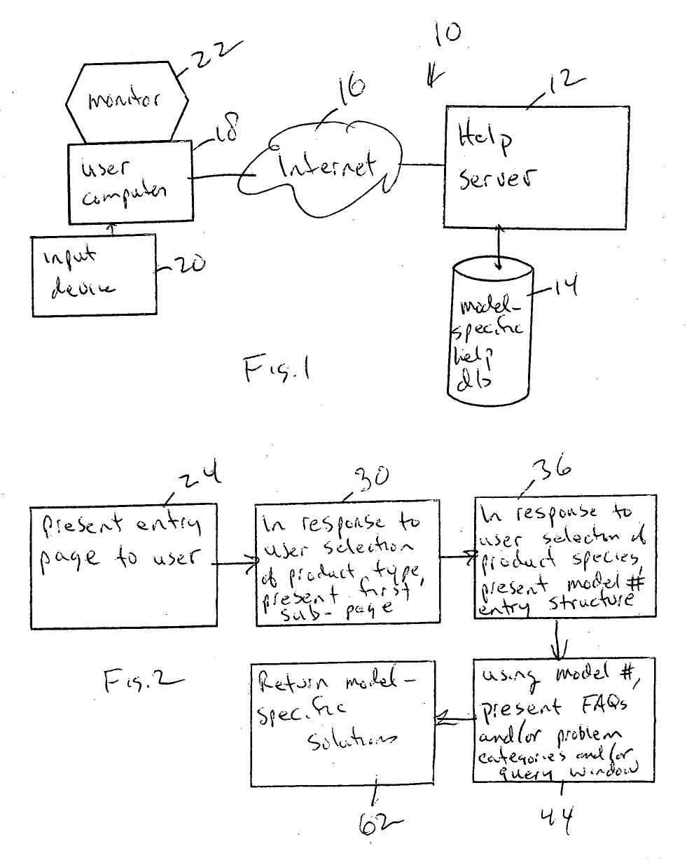

Referring initially to FIG. 1, a system is shown, generally designated 10, which includes one or more Web servers 12 that may access one or more product help databases 14 in response to user queries over the Internet 16 from user computers 18. The database 14 may arrange help data in such as way as to associate common product problems and other information including documentation and driver information with product model designations. As set forth further below, this enables the server 12 to query the database 14 with a model designation and the database 14 to return in response only information associated with the model designation.

Each user computer 18 may have one or more input devices 20 and one or more output devices, such as a monitor 22 on which the screen shots shown below may be displayed.

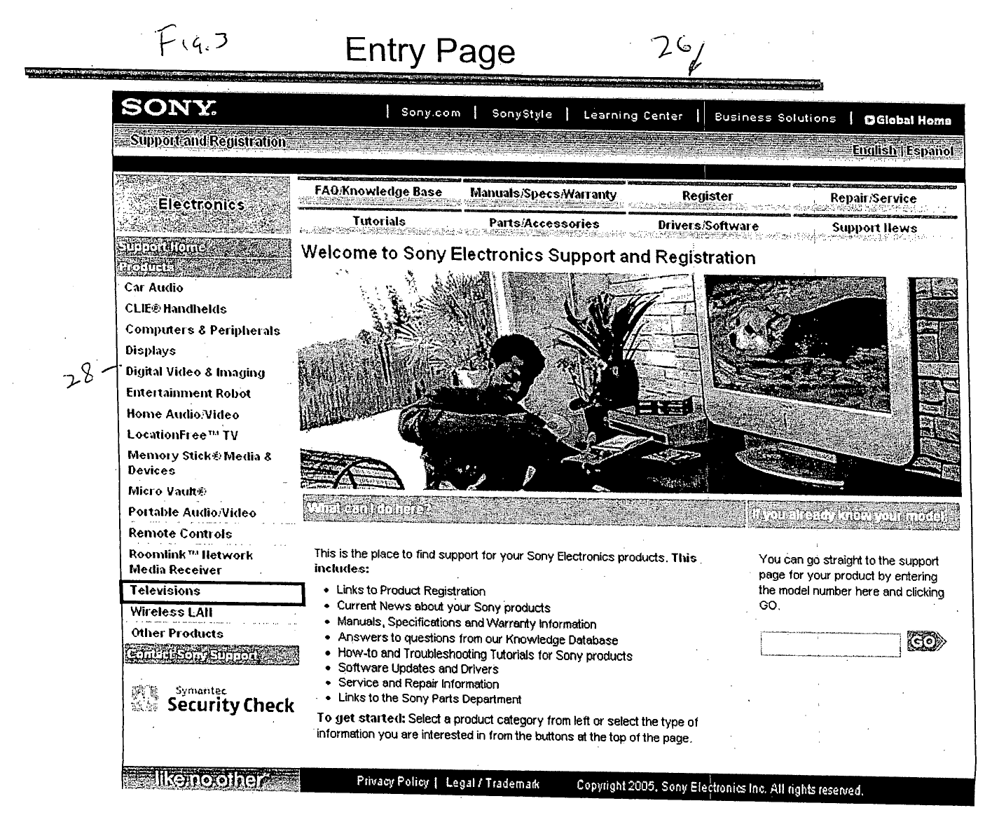

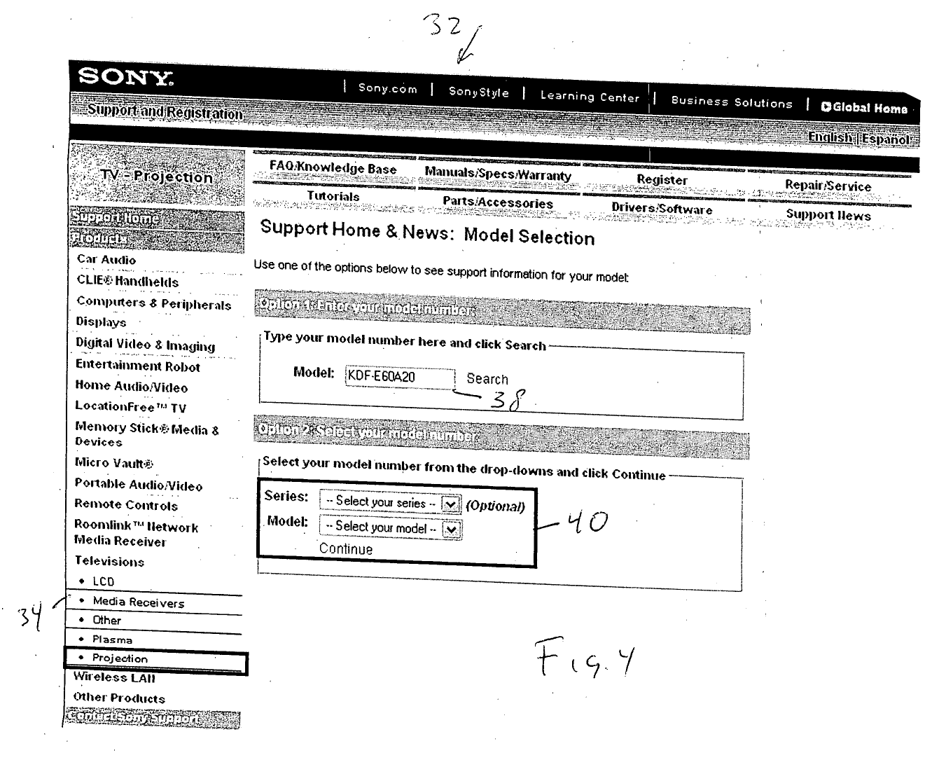

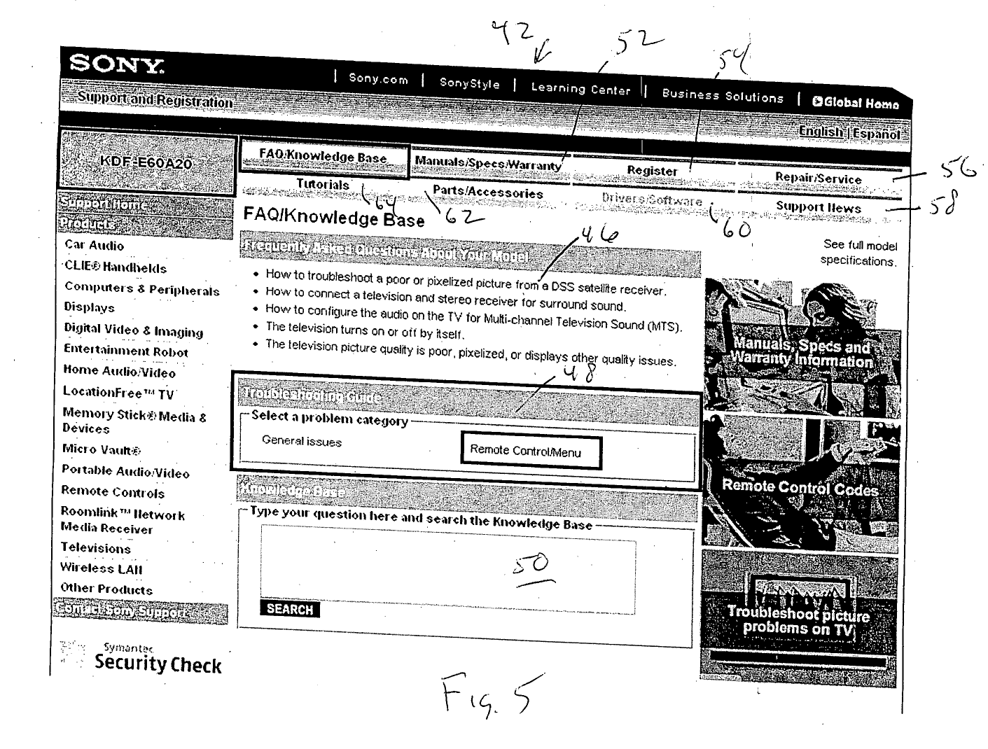

FIG. 2 shows the logic and FIGS. 3-7 show various screen shots in accordance with the logic of one non-limiting illustrative implementation of the present system 10. At block 24 in FIG. 2 the entry page 26 shown in FIG. 3 is displayed when a user accesses the server 12. As shown, the entry page 26 may include a column 28 of product types, including displays, computers, and televisions. At block 30 in FIG. 2 a user can select a product from the list 28. In FIG. 3, the user has selected “televisions” as indicated by the box around the word “televisions”. This causes the server 12 to present to the user computer 18 the first level sub-page 32 shown in FIG. 4.

As shown, the first level sub-page 32 may present a list 34 of product species or sub-categories, e.g., types of TVs, in one case as a sub-list under the selected product from the main product list as shown. One or more model designation options may be displayed, some of which may be in response to the user selecting a product species at block 36 in FIG. 2. By way of non-limiting example, a model designation entry field 38 may be presented on a page as shown in FIG. 4, including on any of the pages shown herein. The user may directly input the model number of a particular electronic product, if known, in the field 38. Or, in response to knowing the type and species of product for which the user is seeking help, a drop-down menu 40 of model series and/or model designations from which the user can select a model designation may be presented.

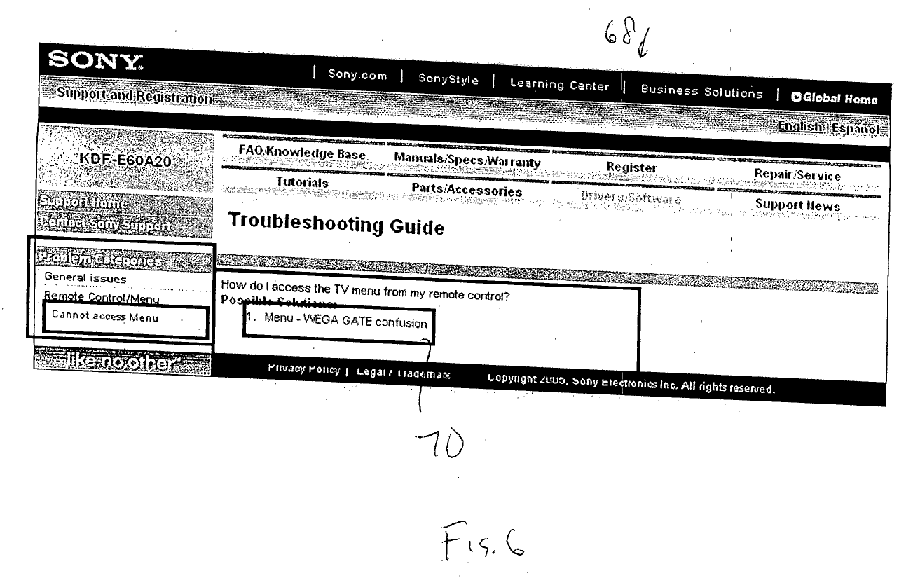

Regardless of how it is communicated to the server 12, once the server 12 knows the model designation of the product for which the user desires help, a second level sub-page 42 (FIG. 5) may be presented at logic block 44 in FIG. 2. As shown, the second level sub-page 42 displays content that is related to the model designation that the user entered, it being understood that substantially all the content on the page 42 including frequently asked questions (FAQs) and problem categories is related to the specific model designation that the user has input. In other implementations the FAQ section may not be model specific.

As shown, the content on the page 42 may include a list 46 only of frequently asked questions pertaining to the specific model designation, from which list the user can select a FAQ (although as stated above the FAQ feature may not be model specific). Thus, in some embodiments the content on the page 42 does not include frequently asked questions that are not related to the model designation. In addition to or in lieu of the list 46, the content of the page 42 may include problem categories 48 that are related to the specific model designation, and no problem categories not related to the model designation. Yet again, the content of the page 42 may include a window 50 into which a user can enter a query, such that the query can be used by the server 12 to search the database 14 for returning responses related only to the model designation, although in some embodiments the responses to queries typed into the window 50 may not be model-specific.

In preferred non-limiting implementations, not only are problem selections presented for the user's choice related substantially only to the specific model of the product for which help is sought, but also other information. For instance, once the model number or designation is entered, all model-specific information (and only model-specific information) can be made available in one location on a single page 42, e.g., the user can click a documentation button 52 to obtain model-specific information related to product manuals, specifications, and warranties. The user can also click a registration button 54 such that a registration page related only to the product model is returned for filling in, and a repair/service button 56 can be selected as well to return repair information related only to the product model number, e.g., locations of facilities that can repair products of the particular model number that has been entered. A news button 58 may be selected to return only news items related to the model number of the product, and a driver/software button 60 may be selected to make available for download only software that pertains to the input model number. Model number-specific parts and accessories may be viewed by selecting a parts/accessories button 62, and model number-specific tutorial information only returned in response to selecting a tutorial button 64. In general, as indicated at block 66 in FIG. 2, model-specific information including model-specific solutions, and only model-specific information, is returned to the user, so that the user need not wade through information that is irrelevant to the particular model designation of his or her product for which help is desired.

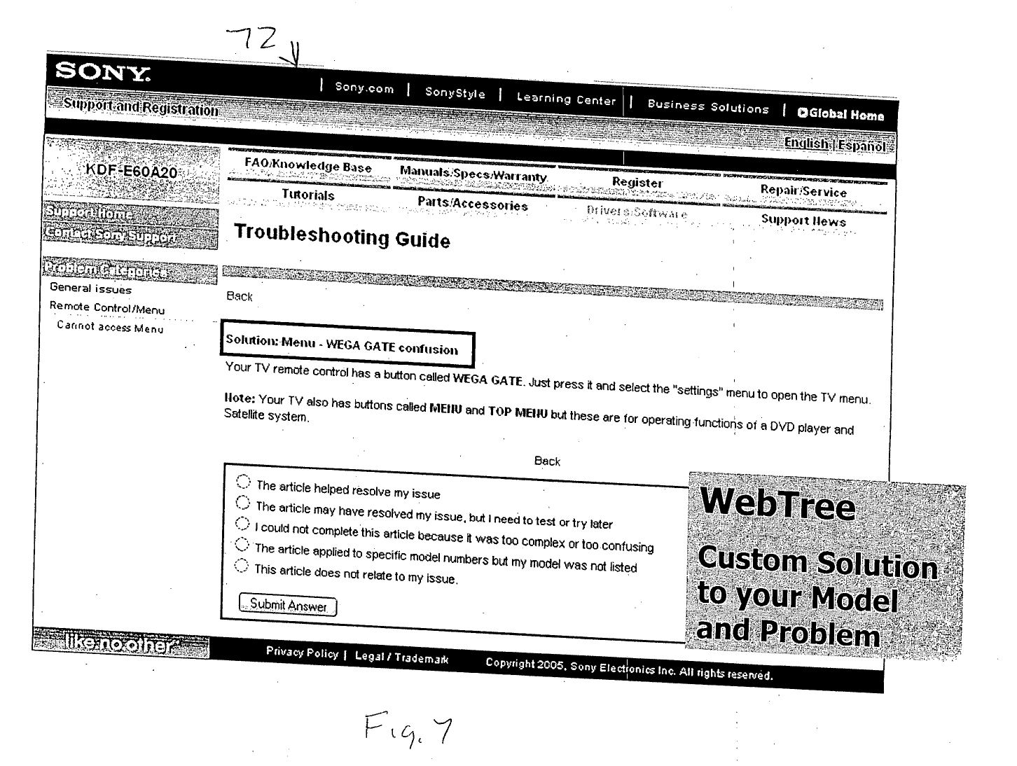

This is further illustrated by noting that in FIG. 5, a “remote control/Menu” button has been selected from the problem categories 48. This causes a third level sub-page 68 to appear on the user's monitor. In the non-limiting illustrative embodiment shown, the sub-page 68 includes a common problem window 70 that relates to the problem selection from the second level sub-page shown in FIG. 5. In the embodiment shown, the common problem is the inability to access the TV menu using a remote control associated with the TV, with the model-specific solution of “WEGA GATE confusion” being returned. If the user selects this solution, details can be presented on a fourth level sub-page 72 shown in FIG. 7, which advises the user how to address the problem noted in FIGS. 5 and 6.

In non-limiting implementations the Pareto principle may be used to establish problem categories, with the goal of accurately solving the typically 20% of the problems that cause 80% of the customer calls. Five to nine categories may be psychologically optimum. The decision tree methodology enables the user to quickly identify whether his problem is listed or not. Problems and solutions may be offered only for in-warranty models.

While the particular SYSTEM AND METHOD FOR MODEL-SPECIFIC WEB HELP as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for providing online help to a user, comprising:
prompting the user to enter a model designation of an electronic product for reception thereof over a wide area network;
based on the model designation, returning to the user, over the wide area network, at least one list of problems associated with the electronic product;
receiving a user selection of an item on the list; and
returning a proposed solution to the user based on the user selection.

2. The method of claim 1, wherein the product is a visual display.

3. The method of claim 1, wherein the product is a television.

4. The method of claim 1, wherein the product is a computer.

5. The method of claim 1, comprising presenting an entry page to the user listing product categories.

6. The method of claim 5, comprising presenting a first sub-page to the user listing sub-categories of a category selected by the user from the entry page.

7. The method of claim 6, comprising presenting, on the first sub-page, a model entry field into which the user can enter the model designation, and a drop-down menu of model designations from which the user can select a model designation.

8. The method of claim 7, comprising presenting a second sub-page having content related to a model designation entered on the first sub-page, the content including a list of frequently asked questions related to the model designation from which the user can select, the content not including frequently asked questions not related to the model designation.

9. The method of claim 7, comprising presenting a second sub-page having content related to a model designation entered on the first sub-page, the content including problem categories related to the model designation, and no problem categories not related to the model designation.

10. The method of claim 7, comprising presenting a second sub-page having content related to a model designation entered on the first sub-page, the content including a window into which a user can enter a query, the query being used to search a database for returning responses related substantially only to the model designation.

11. A system for providing help to a user, comprising:
a server computer communicating with the Internet and executing logic comprising:
receiving a model designation of an electronic product from a user computer; and
based on the model designation, returning to the user computer a list of problems associated with the electronic product, the list not including any information not related to the electronic product.

12. The system of claim 11, wherein the product is selected from the group of products consisting of: a visual display, a television, and a computer.

13. The system of claim 11, wherein the logic includes presenting an entry page to the user listing product categories.

14. The system of claim 13, wherein the logic includes presenting a first sub-page to the user listing sub-categories of a category selected by the user from the entry page.

15. The system of claim 13, wherein the logic includes presenting, on a first sub-page, a model entry field into which the user can enter the model designation, and a drop-down menu of model designations from which the user can select a model designation.

16. The system of claim 13, wherein the logic includes presenting a sub-page having content related to a model designation, the content including a list of frequently asked questions related to the model designation from which the user can select, the content not including frequently asked questions not related to the model designation.

17. The system of claim 13, wherein the logic includes presenting a sub-page having content related to a model designation, the content including problem categories related to the model designation, and no problem categories not related to the model designation.

18. The system of claim 13, wherein the logic includes presenting a sub-page having content related to a model designation, the content including a window into which a user can enter a query, the query being used to search a database for returning responses related substantially only to the model designation.

19. A model-specific help database system, comprising:
at least one Internet server computer;
at least one database accessible to the server computer and associating common product problems with product model designations, whereby the server computer can query the database with a model designation and the database returns in response substantially only common product problems associated with the model designation, the server computer in turn sending the common product problems to a user computer over the Internet.
